(19) United States
(12) Patent Application Publication
(10) Pub. No.: US 2014/0354242 A1
(43) Pub. Date: Dec. 4, 2014

(54) DEVICE AND CHARGE CONTROL METHOD

(71) Applicant: Kabushiki Kaisha Toshiba, Tokyo (JP)

(72) Inventor: Tomonori Tsutsui, Ome-shi (JP)

(73) Assignee: KABUSHIKI KAISHA TOSHIBA, Tokyo (JP)

(21) Appl. No.: 14/133,119

(22) Filed: Dec. 18, 2013

(30) Foreign Application Priority Data
May 30, 2013 (JP) 2013-113952

(51) Int. Cl. H02J 7/00

(52) U.S. Cl. CPC H02J 7/0029
USPC 320/162

(57) ABSTRACT

According to one embodiment, an electronic device includes a controller and a charging circuit. The controller is configured to perform power management of the electronic device. The controller is configured to detect that a battery is in an overvoltage state if conditions that the battery is being charged, a charging current value of the battery acquired from a first IC is not greater than a first threshold, and power usable by the charging circuit to charge the battery is unrestricted are satisfied, and to stop charging of the battery by a charging circuit in response to detection of the overvoltage state of the battery.

### CROSS-REFERENCE TO RELATED APPLICATIONS

This application is based upon and claims the benefit of priority from Japanese Patent Application No. 2013-113952, filed May 30, 2013, the entire contents of which are incorporated herein by reference.

### FIELD

Embodiments described herein relate generally to an electronic device and a method of charge control applied to the electronic device.

### BACKGROUND

Recently, various electronic devices, such as tablet computers and notebook computers, have been developed. Most of these types of electronic devices are designed to be powered by battery.

In charging a battery, a voltage (overvoltage) greater than the full-charge voltage of the battery may occur. If this happens, charging of the battery must be stopped to prevent battery degradation.

However, once the voltage of the battery is no longer an overvoltage, charging will be resumed, and if an overvoltage occurs again later, charging will be stopped. As described above, by a repetition of stopping and resuming charging, the temperature of the battery may rise, causing the battery to catch fire in the case where a foreign particle exists in the battery, for example.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing the outside appearance of an electronic device according to an embodiment.

FIG. 2 is a block diagram showing a system configuration example of the electronic device according to the embodiment.

FIG. 3 is an exemplary block diagram for explaining a charge control process which is executed by the electronic device according to the embodiment.

FIG. 4 is a diagram for explaining an example of step charging which takes place when a battery provided in the electronic device according to the embodiment is charged.

FIG. 5 is a diagram for explaining an example of an operation of charging the battery, which is executed by the electronic device according to the embodiment.

FIG. 6 is a diagram for explaining an example of an operation of stopping the charging of the battery, which is executed by the electronic device according to the embodiment.

FIG. 7 is an exemplary flowchart showing steps of the charge control process which is executed by the electronic device according to the embodiment.

FIG. 8 is an exemplary flowchart showing steps of an overvoltage state release process which is executed by the electronic device according to the embodiment.

### DETAILED DESCRIPTION

Various embodiments will be described hereinafter with reference to the accompanying drawings.

In general, according to one embodiment, an electronic device includes a controller and a charging circuit. The controller is configured to perform power management of the electronic device. The charging circuit is configured to charge a battery by using DC power from an AC power supply device. The battery includes a first IC configured to output information regarding the battery and a second IC configured to detect whether a voltage of the battery is an overvoltage, and turn off a switch in a charging line in the battery if it is detected that the voltage of the battery is the overvoltage. The controller is configured to detect that the battery is in an overvoltage state if conditions that the battery is being charged, a charging current value of the battery acquired from the first IC is not greater than a first threshold, and power usable by the charging circuit to charge the battery is unrestricted are satisfied, and to stop charging of the battery by the charging circuit in response to detection of the overvoltage state of the battery.

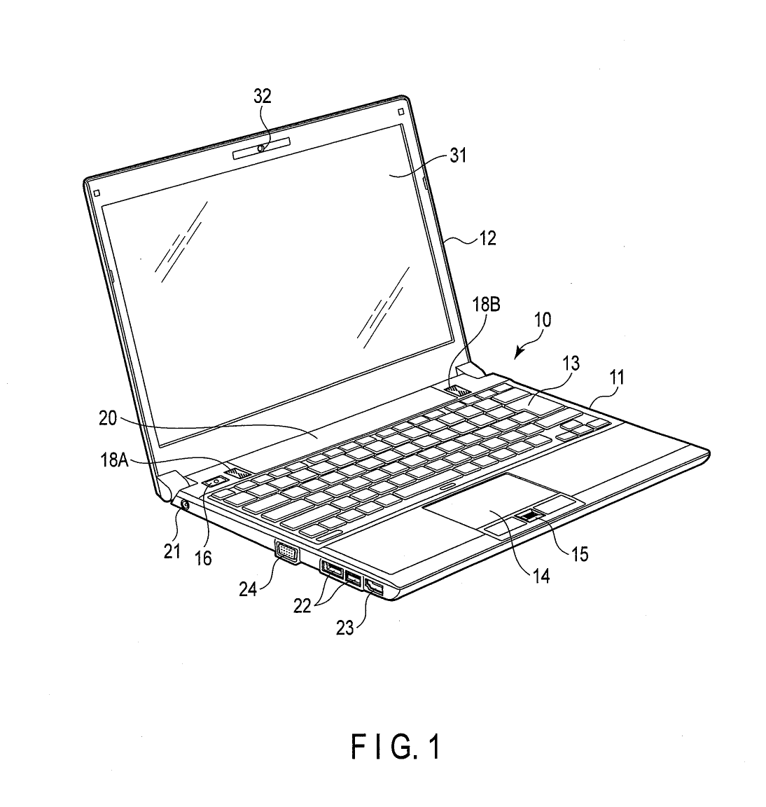

First of all, a structure of an electronic device according to the present embodiment will be described with reference to FIG. 1. This electronic device may be realized as a notebook computer or a tablet computer, for example. It is assumed that the electronic device is realized as a notebook computer 10.

FIG. 1 is a perspective view of the computer 10 with a display unit opened seen from the front. The computer 10 includes a computer main body 11 and a display unit 12. In the display unit 12, a display unit, such as a liquid crystal display (LCD) 31, is incorporated. Further, at a top end portion of the display unit 12, a camera (web camera) 32 is arranged. In addition, the computer 10 is configured to receive power from a battery 20.

The display unit 12 is arranged on the computer main body 11 to be rotatable between an open position at which a top surface of the computer main body 11 is exposed and a closed position at which the top surface of the computer main body 11 is covered by the display unit 12. The computer main body 11 has a thin box-shaped housing, and on top of that, a keyboard 13, a touchpad 14, a fingerprint sensor 15, an electric power switch 16 for power on/off of the computer 10, and a speaker 18A and a speaker 18B are arranged.

The computer main body 11 is provided with a power connector (DC power input terminal) 21. The power connector 21 is provided on a side, for example, on the left side of the computer main body 11. An external power supply device is removably connected to the power connector 21. As the external power supply device, an AC adapter can be used. The AC adapter is a power supply device which converts commercial power (AC power) into DC power.

The battery 20 is removably mounted at a rear end portion of the computer main body 11, for example. The battery 20 may be one which can be accommodated in the computer 10. The computer 10 is powered by the external power supply device or battery 20. If the external power supply device is connected to the power connector 21 of the computer 10, the computer 10 is powered by the external power supply device. During a period in which the external power supply device is not connected to the power connector 21 of the computer 10, the computer 10 is powered by the battery 20. Further, the power from the external power supply device is also used to charge the battery 20.

On the computer main body 11, several USB ports 22, a High-definition Multimedia Interface (HDMI) (registered trademark) output terminal 23, and an RGB port 24 are provided.

In the present embodiment, it is assumed that the battery 20 is mounted in the computer 10 as a one-cell series battery pack, for example. The one one-cell series battery pack is a battery pack in which the number of battery cells to be connected in series is one.

The one-cell series battery pack generally has a protection control function independent of the computer 10. With the battery pack having such an independent (closed) protection control function in the battery pack, if an overvoltage of the battery cell is detected, charging is stopped by the protection control function within the battery pack. Therefore, there may be a situation where a host cannot determine that an overvoltage of the battery cell has been detected. If the host continues to charge the battery even though overvoltage of the battery cell has been detected, the temperature of the battery cell gradually rises, which may cause the battery cell to catch fire.

The computer 10 has the function of detecting an overvoltage state of the battery 20 from a charging current state during the charging of the battery 20 without adding special hardware within the battery 20 structured by such a one-cell series battery pack. Thus, the temperature of the battery cell within the battery 20 can be prevented from being increased.

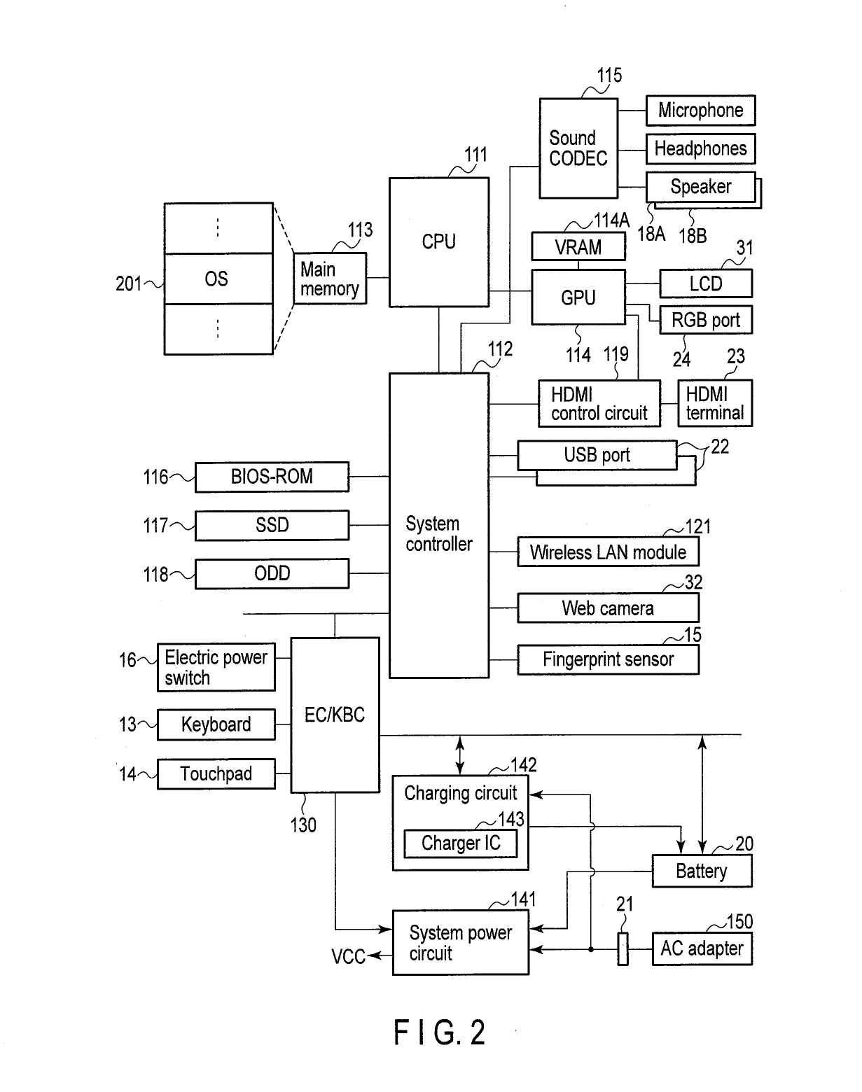

FIG. 2 shows a system configuration of the computer 10.

The computer 10 includes a CPU 111, a system controller 112, a main memory 113, a graphics processing unit (GPU) 114, a sound CODEC 115, a BIOS-ROM 116, a solid-state drive (SSD) 117, an optical disc drive (ODD) 118, an HDMI control circuit 119, a wireless LAN module 121, an embedded controller/keyboard controller (EC/KBC) IC 130, a system power circuit 141, a charging circuit 142, etc.

The CPU 111 is a processor which controls an operation of each component of the computer 10. The CPU 111 executes various kinds of software loaded into the main memory 113 from the SSD 117. The software includes an operating system (OS) 201, etc.

The CPU 111 also executes a basic input/output system (BIOS) stored in the BIOS-ROM 116, which is a nonvolatile memory. The BIOS is a system program for controlling hardware.

The GPU 114 is a display controller which controls the LCD 31 used as a display monitor of the computer 10. The GPU 114 generates a display signal (LVDS signal) which should be supplied to the LCD 31 from display data stored in a video memory (VRAM) 114A. Further, the GPU 114 can generate an analog RGB signal and an HDMI video signal from the display data. The analog RGB signal is supplied to an external display through the RGB port 24. The HDMI output terminal 23 can send the HDMI video signal (uncompressed digital video signal) and a digital audio signal to the external display by a single cable. The HDMI control circuit 119 is an interface for sending the HDMI video signal and the digital audio signal to the external display through the HDMI output terminal 23.

The system controller 112 is a bridge device for connecting between the CPU 111 and each component. A serial ATA controller for controlling the SSD 117 is embedded in the system controller 112.

The EC/KBC 130 is a power management controller for executing power management of the computer 10, and is realized as a one-chip microcomputer in which a keyboard controller for controlling the keyboard (KB) 13 and the touchpad 14, for example, is included. The EC/KBC 130 has the function of powering on or powering off the computer 10 in accordance with an operation of the electric power switch 16 by a user. The power on and power off control of the computer 10 is executed by a cooperative operation of the EC/KBC 130 and the system power circuit 141.

In the present embodiment, it is possible to determine that the battery 20 is in an overvoltage state based on the state of the charging current. More specifically, when firmware of the EC/KBC 130 charges the battery 20, while determining a state of a charger IC 143 in the charging circuit 142 and the state of a gas gauge IC 52 in the battery 20, starting or stopping of the charging of the battery 20 is determined. The charger IC 143 is an IC which controls charging. The gas gauge IC 52 is an IC which is configured to provide information regarding various states of the battery cell in the battery 20 to a host.

The system power circuit 141 is a power circuit configured to supply power (operating power Vcc) to each component in the computer 10 by using power (DC power) from the battery 20 or power (DC power) from an AC adapter 150. A power input terminal of the system power circuit 141 is connected to the power connector 21. Therefore, if the AC adapter 150 is connected to the power connector 21 through a power cable, the system power circuit 141 can receive the power (DC power) from the AC adapter 150.

When an on-signal transmitted from the EC/KBC 130 is received, the system power circuit 141 supplies the operating power to each component in the computer 10. Further, when an off-signal transmitted from the EC/KBC 130 is received, the system power circuit 141 stops the supply of the operating power to each component.

The EC/KBC 130 can communicate with each of the charging circuit 142 and the battery 20 via a serial bus. The charging circuit 142 is a circuit for charging the battery 20 by using the DC power from the AC adapter 150. The charging circuit 142 includes the charger IC 143 which is configured to control the charging current and a charging voltage output to the battery 20 from the charging circuit 142. The charging current is an adjusted output current of the charging circuit 142, and used to charge the battery 20. The charging voltage is an adjusted output voltage of the charging circuit 142, and referred to as a battery voltage.

The EC/KBC 130, the system power circuit 141, the charging circuit 142, and the charger IC 143 operate even in a period in which the computer 10 is powered off.

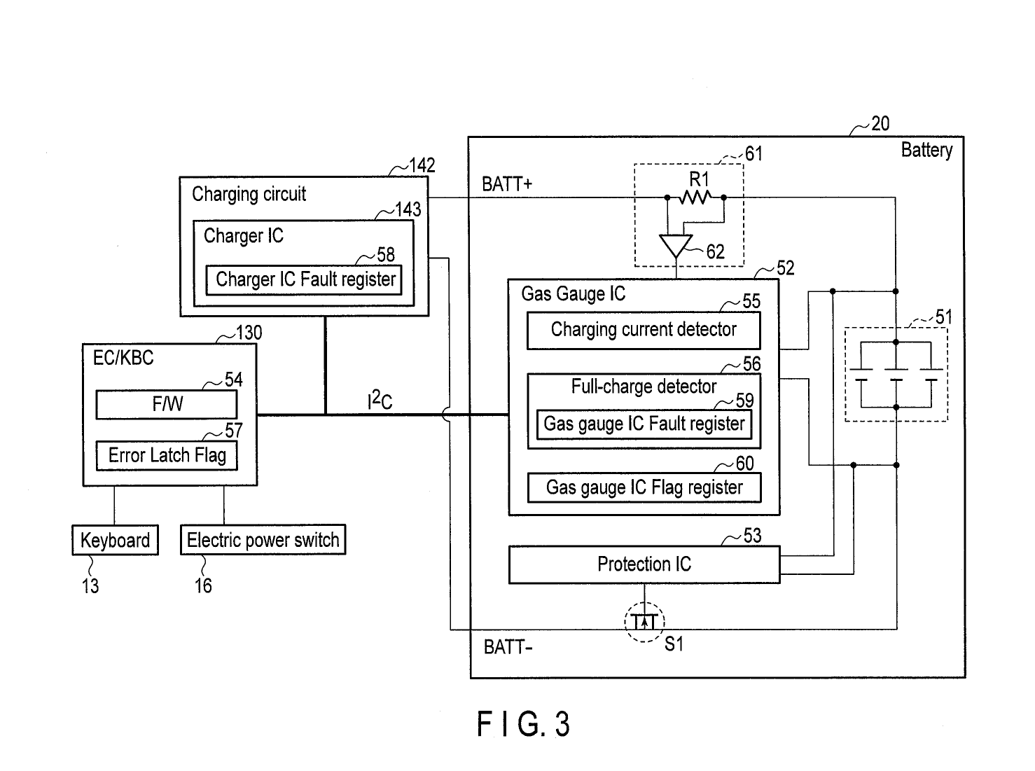

Next, the charge control processing of the present embodiment will be described with reference to the block diagram of FIG. 3.

The battery 20 includes a battery cell 51, the gas gauge IC 52, a protection IC 53, etc. The charging circuit 142 is connected to the battery 20 via the positive terminal (BATT+) of the battery 20 and the negative terminal (BATT−) of the battery 20. Further, the battery 20, the charging circuit 142, and the EC/KBC 130 are connected by an I²C bus, which is a serial bus, and can communicate with each other. Instead of the I²C bus, a System Management bus (SMbus) may be used.

The EC/KBC 130 includes firmware (F/W) 54. The firmware 54 starts the charging of the battery 20 when the following five conditions are satisfied:

(1) There is no error status in the charger IC 143.

(2) There is no error status in the gas gauge IC 52 of the battery 20.

(3) Communication between the EC/KBC 130 and the gas gauge IC 52 can be performed normally.

(4) The battery 20 is not fully charged.

(5) The voltage of the battery 20 is not an overvoltage.

The charging circuit 142 includes the charger IC 143 as stated above. The charger IC 143 is an IC for controlling the charging of the battery 20. Further, the charger IC 143 includes a charger IC fault register 58 which indicates whether there is an error status in the charger IC 143.

The firmware 54 refers to the charger IC fault register 58 and determines whether there is an error status in the charger IC 143.

The battery cell 51 includes a single serial cell, and as shown in FIG. 3, for example, the battery cell 51 includes three cells connected in parallel (one-cell series three parallel cells).

If a plurality of cells as shown in FIG. 3 are connected in parallel, an overvoltage occurs when the balance between the voltages of each of the cells is lost.

The gas gauge IC 52 is connected to the positive and negative poles of the battery cell 51. The gas gauge IC 52 is a communication IC which can send battery information to the EC/KBC 130 by communicating with the EC/KBC 130 via the I²C bus. The battery information is information which indicates a value of the present charging current (hereinafter referred to as charging current information), for example. The battery information is information which indicates whether the battery cell 51 is fully charged or not (hereinafter referred to as full-charge information), for example. Further, the gas gauge IC 52 controls the charge in the battery 20. More specifically, the gas gauge IC 52 calculates the spare capacity of the battery cell 51. The spare capacity of the battery cell 51 is a ratio of the charged capacity to the full-charge capacity, for example.

The gas gauge IC 52 includes a charging current detector 55, a full-charge detector 56, and a gas gauge IC flag register 60. The charging current detector 55 detects a charging current which flows through a charging line in the battery 20. The charging line is a line which connects the positive terminal (BATT+) of the battery 20 and the negative terminal (BATT−) of the battery 20. The gas gauge IC 52 can send the charging current information detected by the charging current detector 55 to the EC/KBC 130.

The charging current detector 55 detects the charging current by using a detection circuit 61, for example. The detection circuit 61 includes charging current detection resistor R1 and a comparator 62. The detection circuit 61 detects the charging current based on the voltage across the two ends of charging current detection resistor R1.

The full-charge detector 56 detects whether the battery cell 51 is fully charged. The full-charge detector 56 stores the full-charge information indicating whether the battery cell 51 is fully charged in a gas gauge IC fault register 59. The gas gauge IC 52 can send the full-charge information stored in the gas gauge IC fault register 59 to the EC/KBC 130.

The gas gauge IC 52 includes the gas gauge IC flag register 60 which indicates whether there is an error status in the gas gauge IC 52. The firmware 54 can determine whether there is an error status in the gas gauge IC 52 by referring to the gas gauge IC flag register 60.

Further, the full-charge detector 56 includes the gas gauge IC fault register 59 which stores the full-charge information. The firmware 54 can determine whether the battery 20 is fully charged by referring to the gas gauge IC fault register 59.

As the fifth condition, the firmware 54 refers to an error latch flag 57 in the EC/KBC 130 to determine whether the battery 20 (battery cell 51) is in an overvoltage state. The error latch flag 57 shows whether the charging of the battery 20 has been stopped as a result of the determination that the battery 20 is in the overvoltage state. In other words, the error latch flag 57 shows whether the battery 20 is in the overvoltage state. The overvoltage state will be described later.

When all of the aforementioned five conditions are satisfied, the firmware 54 notifies the charger IC 143 to start charging, and the charger IC 143 starts charging by supplying the charging current to the battery 20.

The protection IC 53 is connected to the positive pole and the negative pole of the battery cell 51. Further, the protection IC 53 turns on or off switch S1 in the charging line. Switch S1 is an FET, for example.

The protection IC 53 is an IC for monitoring the voltage of the battery cell 51. More specifically, the protection IC 53 detects whether the voltage of the battery 20 (battery cell 51) is an overvoltage based on the voltage of the two ends of the battery cell 51 (hereinafter referred to as battery cell voltage). Concretely, the protection IC 53 detects that the voltage of the battery 20 (battery cell 51) is an overvoltage if the battery cell voltage during charging exceeds a predetermined threshold which has been set in advance. The protection IC 53 performs control to turn switch S1 from an on state to an off state if an overvoltage has been detected.

Overvoltage of the battery 20 detected by the protection IC 53 will be described below merely as an overvoltage. On the other hand, overvoltage of the battery 20 determined by the firmware 54 will be referred to as an overvoltage state.

As can be seen, the firmware 54 starts the charging based on the five conditions stated above. The firmware 54 starts the charging by instructing the charger IC 143 to supply the charging current to the battery 20 if the five conditions are satisfied, for example.

Next, a detection process of the overvoltage state of the battery 20 by the firmware 54 will be described.

The firmware 54 detects the overvoltage state of the battery 20 and stops the charging of the battery 20 if the following four conditions are satisfied.

(1) The firmware 54 has not detected the overvoltage state.

(2) The battery 20 is being charged.

(3) A value of the charging current is not greater than 50 mA.

(4) The charger IC 143 does not restrict charging because of a high load.

The firmware 54 determines that the battery 20 is in the overvoltage state if all of the above four conditions are satisfied, and stops the charging of the battery 20.

The four conditions will be specifically described.

The firmware 54 can determine whether the battery 20 has stopped charging because of an overvoltage state by referring to the error latch flag 57.

The firmware 54 can determine whether the battery 20 is being charged or not by communicating with the charger IC 143. Alternatively, the firmware 54 can determine whether the battery 20 is being charged or not by referring to the error latch flag 57. The firmware 54 may determine that the aforementioned second condition for detecting the overvoltage state of the battery 20 is satisfied if the battery 20 is being charged and there is no error information regarding charging with reference to the charger IC fault register 58 of the charger IC 143. That is, the firmware 54 may determine that the battery 20 is being charged on condition that charging of the battery 20 is performed normally.

During a period in which the battery 20 is charged by the charger IC 143, the gas gauge IC 52 can detect the charging current supplied to the battery cell 51. Further, since the gas gauge IC 52 and the EC/KBC 130 are connected to each other by a communication line, the firmware 54 can obtain information on the charging current periodically from the gas gauge IC 52.

As stated above, the protection IC 53 turns off switch S1 if an overvoltage of the battery cell 51 is detected. Therefore, if the voltage of the battery cell 51 is an overvoltage, the charging line will be interrupted by switch S1, and therefore, a value of the charging current to be detected by the gas gauge IC will be practically zero. The aforementioned third condition for detecting the overvoltage state of the battery 20 (namely, the value of the charging current is not greater than 50 mA) is used as the condition for determining that switch S1 is in the off state. That is, the aforementioned third condition for detecting the overvoltage state of the battery 20 is used as the condition for determining that the protection IC 53 detects the overvoltage of the battery cell 51. In the present embodiment, a threshold value of the charging current for detecting that switch S1 is in the off state is set to zero or a value near zero. Specifically, considering a design margin, the charging current threshold is set to 50 mA. Further, this value of 50 mA is lower than a value of final charging current to be described later with reference to FIG. 5. The firmware 54 can detect whether the present charging current is smaller than or equal to the charging current threshold based on the information on the charging current value acquired from the gas gauge IC 52.

The fourth condition is the condition of not being a high-load state in which the power usable by the charging circuit 142 to charge the battery 20 is restricted. Not being a high-load state means that the power usable for charging the battery 20 of the DC power supplied from the AC adapter is not restricted, for example. More specifically, the fourth condition means that the value of the charging current is not controlled by the charger IC 143 to be smaller than the maximum charging current value which is set in advance. To be more precise, in a case where the power supplied to the computer 10 from the AC adapter is 30 W and the maximum power which can be supplied to charge the battery 20 is 15 W, if 20 W is used to drive a system of the computer 10, the power usable to charge the battery 20 is restricted to 10 W. As stated above, if the power supplied to the battery 20 to charge the battery 20 is smaller than the maximum power which can be supplied to charge the battery 20, namely, the value of the usable charging current is restricted, the fourth condition is not satisfied. The firmware 54 communicates with the charger IC 143 through the communication line to check whether the charger IC 143 is restricting the charging current.

As can be seen, by using the fourth condition, false detection of an overvoltage which occurs when charging is restricted can be prevented. In other words, it is possible to prevent false detection of an overvoltage state where it should not be detected as an overvoltage normally, and prevent charging from being stopped.

Further, if the charging current is restricted, there is a low risk of heat generation, etc., caused by step charging since the charging current has been restricted (the charging current is smaller than the maximum charging current). Accordingly, when the charging current is restricted, by preventing charging from being stopped, it is possible to avoid a problem of not being able to perform normal charging.

If all of the four conditions are satisfied, the firmware 54 determines that the battery 20 is in the overvoltage state, and stops the charging of the battery 20 by the charging circuit 142 (charger IC 143).

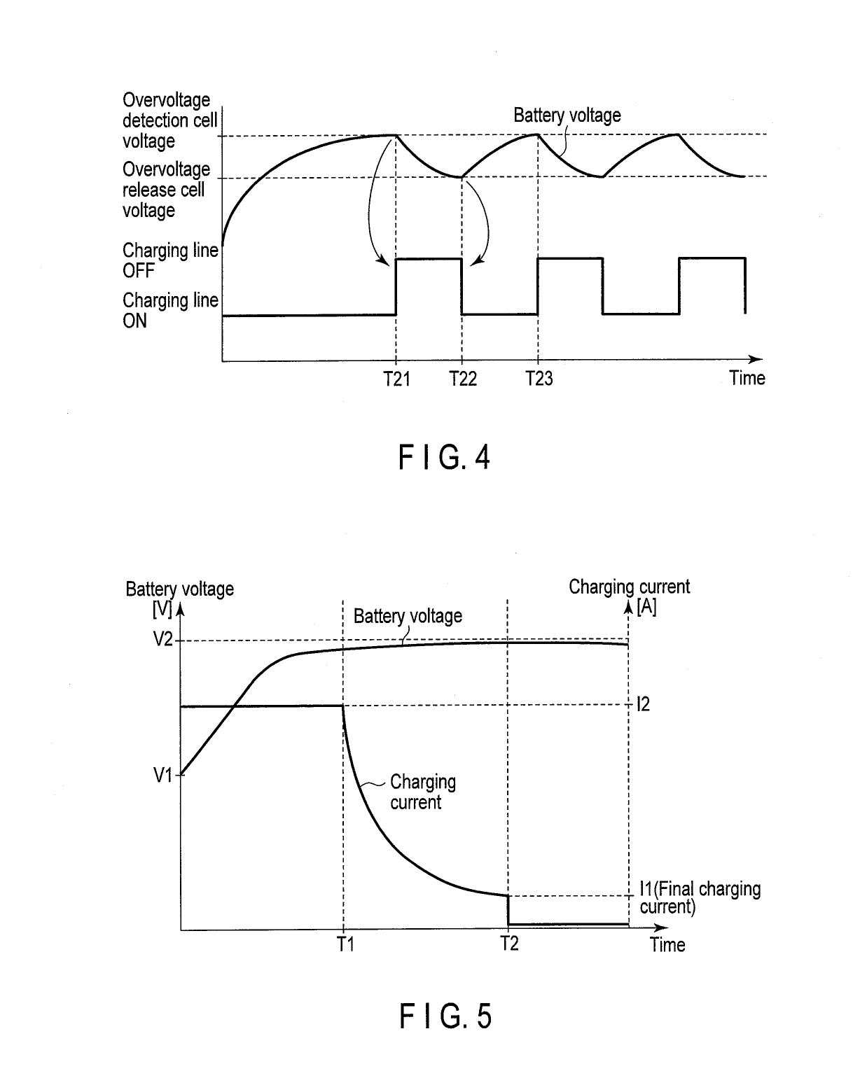

Next, with reference to FIG. 4, step charging, which is performed when an overvoltage is detected by the protection IC 53, will be described. Further, in the present embodiment, the firmware 54 performs control to stop charging of the battery 20 so as to avoid step charging.

Step charging is charging which repeats starting of charging and stopping of charging. More specifically, in step charging, starting of charging and stopping of charging are repeated as “start charge”43 “overvoltage detection”→, “stop charge”→“start charge”→“overvoltage detection”→“stop charge” . . . .

To be more precise, at time T21 of FIG. 4, the battery voltage (voltage of the battery cell 51) reaches a predetermined threshold (overvoltage detection cell voltage) which is set in advance to detect overvoltage. The protection IC 53 turns off switch S1 to the off state (charging line OFF) from the on state (charge line ON). During a period (T21 to T22 shown in FIG. 4) in which switch S1 is in the off state, no charging current flows through the charging line. As can be seen, the protection IC 53 stops charging by preventing the charging current from being supplied to the battery cell 51.

At time T22, the battery voltage is decreased to a predetermined threshold (overvoltage release cell voltage) which is set in advance to release the overvoltage. The protection IC 53 turns switch S1 from the off state to the on state. If the charging circuit 142 continues to supply the charging current to the battery 20, during a period (T22 to T23 shown in FIG. 4) in which switch S1 is in the on state, the charging current flows through the charging line. Therefore, the battery cell 51 is charged again. Accordingly, the battery voltage increases.

Further, at time T23, as the battery voltage reaches the overvoltage detection cell voltage again, the protection IC 53 turns switch S1 to the off state (charging line OFF) from the on state (charging line ON).

As can be seen, as shown in FIG. 4, as the protection IC 53 turns on/off switch S1, step charging occurs. When step charging occurs, if the impedance of the battery cell 51 is high, namely, the battery 20 is degraded or there is a foreign substance, etc., in the battery 20, for example, the temperature of the battery cell 51 may rise, compromising safety.

In the present embodiment, in order to prevent such step charging from occurring, the firmware 54 detects the overvoltage state of the battery 20 and sets a latch to stop charging, thereby performing safer charge control.

Incidentally, the battery 20 assumed in the present embodiment cannot achieve synchronization between the gas gauge IC 52 and the protection IC 53. In other words, in the battery 20, communication cannot be performed between the gas gauge IC 52 and the protection IC 53. For example, the fact that the overvoltage has been detected by the protection IC 53 is not notified to the gas gauge IC 52. For this reason, the gas gauge IC 52 cannot detect the overvoltage. Accordingly, if the protection IC 53 detects the overvoltage, control for stopping the charging in the battery 20 and resumption of charging is performed, and the aforementioned step charging occurs. In the present embodiment, even in a case where synchronization cannot be achieved between the gas gauge IC 52 and the protection IC 53, a charge control process can be performed so that step charging does not occur.

Before describing specific charge control processing of the present embodiment, normal charge control corresponding to the case where an overvoltage is not detected will be described with reference to FIG. 5.

A graph shown in FIG. 5 shows an example of a variation characteristic of the charging current and the battery voltage during the charging period of the battery 20. The vertical axis of the graph represents the battery voltage and the charging current of the battery 20, and the horizontal axis represents time.

Here, it is assumed that the AC adapter 150 is connected to the computer 10 and the battery 20 is not fully charged. A charging operation in this case is executed as stated below, for example.

(1) The battery 20 is constant-current charged by the charging current of I2 [A].

(2) When the voltage of the battery 20 is raised from battery voltage V1 [V] to near certain threshold voltage V2 [V] (T1 in FIG. 5), charging is switched from constant-current charging to constant-voltage charging.

(3) When the battery 20 is fully charged, namely, the output voltage of the battery 20 is raised to an output voltage corresponding to the fully charged state of the battery 20 (T2 in FIG. 5), charging is finished.

Whether the battery 20 is fully charged or not can be detected by the gas gauge IC 52 as described above. Therefore, in the present embodiment, it is possible to detect that the battery 20 has been brought into the full charge state without detecting charging termination current value I1 [A].

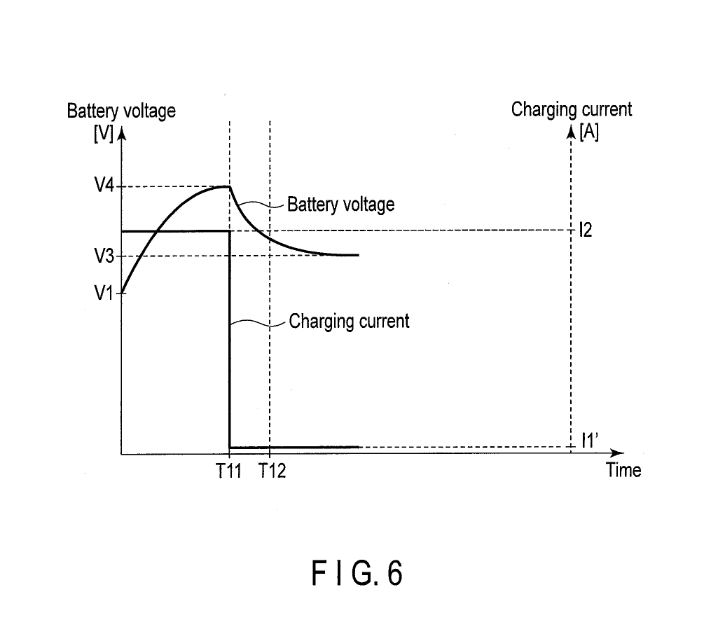

Next, with reference to FIG. 6, a case where the overvoltage state has been detected by the firmware 54 will be described.

(1) The battery 20 is constant-current charged by a charging current of I2 [A].

(2) When the voltage of the battery 20 is raised from battery voltage V1 [V] to near overvoltage V4 [V] (T11 in FIG. 6), the overvoltage is detected by the protection IC 53. Then, since switch S1 is turned to the off state, as shown in FIG. 6, the charging current is rapidly decreased from I2 [A] to I1′ [A]. I1′ [A] is nearly 0 [A], and not greater than 50[mA], for example. Further, I1′ [A] is smaller than charging termination current I1 [A] as shown in FIG. 5.

(3) After the charging current drops to I1′ [A], the firmware 54 stops the charging (T12 in FIG. 6). Times T11 and T12 may be substantially the same. Since the charging is stopped, the battery voltage is decreased to voltage V3 [V], for example.

As can be seen, when the overvoltage occurs during charging, the charging current value detected by the gas gauge IC 52 is not greater than 50 [mA]. Therefore, the firmware 54 can determine whether the battery 20 is in the overvoltage state by obtaining the charging current value from the gas gauge IC 52.

FIG. 6 illustrates the case where the overvoltage occurred during constant-current charging. However, an overvoltage may occur during constant-voltage charging.

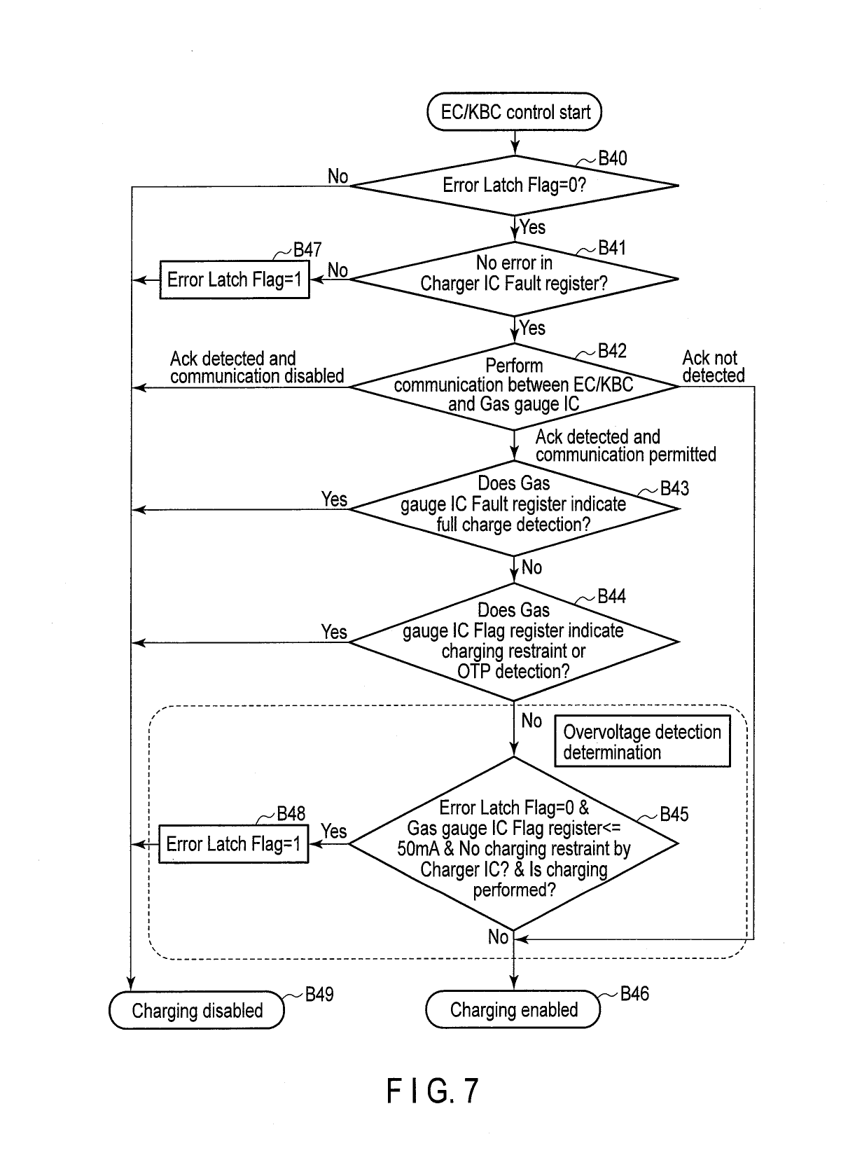

Next, with reference to a flowchart of FIG. 7, blocks of charge control processing of the present embodiment will be described.

When charging the battery 20, the charge control processing by the EC/KBC 130 is started.

Firstly, the firmware 54 refers to the error latch flag 57 and determines whether the overvoltage state of the battery 20 has already been detected (block B40). That is, the firmware 54 stores information on whether charging of the battery 20 has been stopped in the error latch flag 57, and if the stored information shows that charging of the battery 20 has stopped, the charging of the battery 20 is stopped. If the error latch flag 57 does not indicate an overvoltage state (YES in block B40), namely, if the error latch flag=0, the firmware 54 refers to the charger IC fault register 58 and determines whether there is no error in the charger IC 143 (block B41). There being no error in the charger IC 143 means that there is no error regarding the state of an AC adapter, for example. If the error latch flag 57 indicates an overvoltage state (NO in block B40), namely, the error latch flag=1, the firmware 54 does not perform charging (block B49).

If there is no error in the charger IC 143 (YES in block B41), the firmware 54 performs communication between the EC/KBC 130 and the gas gauge IC 52 (block B42).

The firmware 54 starts the charging if an ACK from the gas gauge IC 52 is detected and the firmware 54 succeeded in performing communication between the EC/KBC 130 and the gas gauge IC 52. The firmware 54 then moves to block B43, refers to the gas gauge IC fault register 59, and determines whether the battery 20 is fully charged (block B43).

The firmware 54 does not perform charging if an ACK from the gas gauge IC 52 is detected and the firmware 54 failed in performing communication between the EC/KBC 130 and the gas gauge IC 52 since information necessary for determining the overvoltage state cannot be obtained from the gas gauge IC 52 (block B49).

If there is an error in the charger IC 143 (NO in block B41), the firmware 54 sets the error latch flag 57 (error latch flag 57=1) (block B47), and stores information shows that charging has been stopped.

In addition, if an ACK from the gas gauge IC 52 is not detected, the firmware 54 continues the charging (block B46). A case where an ACK from the gas gauge IC 52 is not detected includes a case where the capacity of the battery cell 51 is smaller than the capacity necessary for operating the gas gauge IC 52 when it is assumed that the gas gauge IC 52 operates by using the power supplied from the battery cell 51, for example. In such a case, by performing charging, it is possible to operate the gas gauge IC 52.

If the battery 20 is not fully charged (NO in block B43), the firmware 54 refers to the gas gauge IC flag register 60 and determines whether charging restraint or overheat protection (over-temperature protection [OTP]) is detected (block B44). If the battery 20 is fully charged (YES in block B43), the firmware 54 stops charging (block B49).

If charging restraint or OTP is not detected (NO in block B44), the firmware 54 determines whether the battery 20 is in the overvoltage state or not (block B45). If charging restraint or OTP is detected (YES in block B44), the firmware 54 stops charging (block B49).

The firmware 54 determines whether the battery 20 is in the overvoltage state or not (block B45). In this block B45, the firmware 54 determines whether the battery 20 is in the overvoltage state based on a determination condition of the overvoltage state described above. If it is determined that the battery 20 is in the overvoltage state (YES in block B45), the firmware 54 sets the error latch flag 57 (error latch flag 57=1) (block B48), and stops the charging.

On the other hand, if it is determined that the battery 20 is not in the overvoltage state (NO in block B45), the firmware 54 continues the charging (block B46).

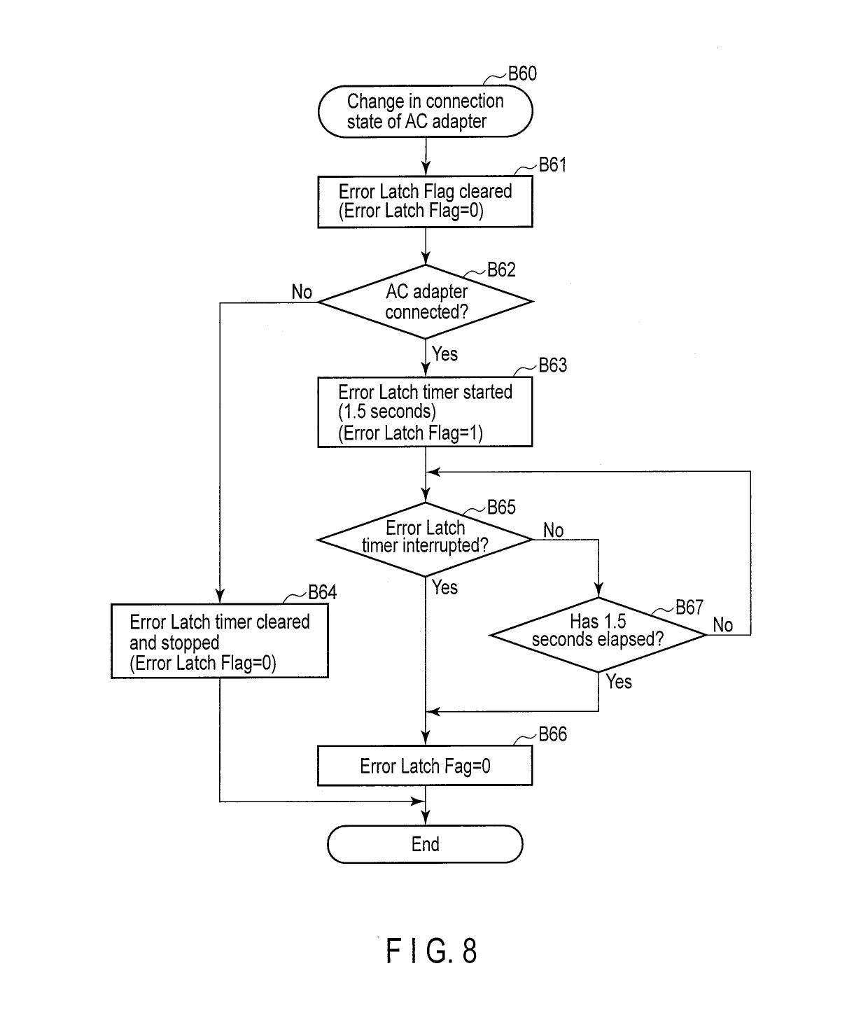

Next, with reference to a flowchart of FIG. 8, blocks of overvoltage state release processing for releasing an overvoltage state will be described.

According to a change made in a connection state of the AC adapter 150, the firmware 54 starts the overvoltage state release processing (block B60). More specifically, when the connection state of the AC adapter is changed from the state where the AC adapter is connected to the computer 10 to a state where it is not connected to the computer 10, or when the same is changed from the state where the AC adapter is not connected to the computer 10 to a state where it is connected to the computer 10, the firmware 54 changes the information stored in the error latch flag 57 to information which shows that charging of the battery 20 should not be stopped. For example, when the AC adapter 150 is removed from the power connector 21 or when the AC adapter 150 is connected to the power connector 21, the firmware 54 starts the overvoltage state release process (block B60). Next, the firmware 54 clears the latched error latch flag 57 (error latch flag=0) (block B61). By clearing the error latch flag 57, even if the state of the battery 20 before the overvoltage state release process is started is the overvoltage state, it is possible to resume charging.

Next, the firmware 54 determines whether the AC adapter 150 is connected to the power connector 21 (block B62). If it is determined that the AC adapter 150 is connected to the power connector 21 (YES in block B62), the firmware 54 sets an error latch flag (error latch flag=1) and starts an error latch timer (block B63). By starting the error latch timer, there is a transitional period in which charging is not performed for a predetermined time (for example, 1.5 seconds) until charging is started after the AC adapter 150 is connected to the power connector 21. Thus, it is possible to prevent the charging from being performed for a time (for example, 1.5 seconds) needed to complete the processing necessary for starting charging, for example, initial operation processing necessary for performing communication between the EC/KBC 130 and the gas gauge IC 52. Further, if it is determined that the AC adapter 150 is removed from the power connector 21 (NO in block B62), the firmware 54 maintains the error latch flag=0 and clears or stops the error latch timer (block B64).

After staring the error latch timer in block B63, the firmware 54 determines whether there was an interrupt in the error latch timer (block B65). If it is determined that there was an interrupt in the error latch timer (YES in block B65), the firmware 54 changes the error latch flag from 1 to 0 (YES in block B65). If it is determined that there was no interrupt in the error latch timer (NO in block B65), the firmware 54 determines whether 1.5 seconds, which is the set time for the error latch timer, has elapsed since the error latch timer was started in block B63 (block B67). If it is determined that 1.5 seconds has elapsed (YES in block B67), the firmware 54 changes the error latch flag from 1 to 0 (block B66). If it is determined that 1.5 seconds has not elapsed since the error latch timer was started in block B63 (NO in block B67), the firmware 54 determines whether there was an interrupt in the error latch timer (block B65).

As described above, in the present embodiment, the EC/KBC 130 in the computer 10 detects whether the battery 20 is in the overvoltage state based on the charging current value acquired from the battery 20. Further, if the battery 20 is in the overvoltage state, charging of the battery 20 is stopped by the control of the EC/KBC 130. Therefore, the charging of the battery 20 can be easily controlled without adding a special circuit in the battery 20 or increasing the number of signal pins for an interface with the battery 20. In addition, as compared to a structure which uses only an overvoltage protection IC in the battery 20, safety of the battery 20 can be enhanced. Further, since the function of detecting an overvoltage does not need to be added to the gas gauge IC 52 which cannot detect the overvoltage, costs can be reduced. Furthermore, since a new communication line, etc., does not need to be added between the computer 10 and the battery 20, the number of pins of the battery connector can be reduced. In addition, a pattern layout of a printed circuit board (PCB) can be deleted.

Since all of the blocks of the charge control processing of the present embodiment can be executed by software, by merely installing and executing a computer program for executing the blocks of the charge control processing in an ordinary computer through a computer-readable storage medium storing these blocks, an advantage similar to that obtained by the present embodiment can easily be realized.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiment described herein may be made without departing from the spirit of the invention. The accompanying claims and their equivalents are intended to cover such forms or modifications as would fall within the scope and spirit of the inventions.

What is claimed is:

1. An electronic device comprising:
a controller configured to perform power management of the electronic device; and
a charging circuit configured to charge a battery by using DC power from an AC power supply device, the battery comprising a first IC configured to output information regarding the battery and a second IC configured to detect whether a voltage of the battery is an overvoltage, and turn off a switch in a charging line in the battery if it is detected that the voltage of the battery is the overvoltage,
wherein the controller is configured to detect that the battery is in an overvoltage state if conditions that the battery is being charged, a charging current value of the battery acquired from the first IC is not greater than a first threshold, and power usable by the charging circuit to charge the battery is unrestricted are satisfied, and to stop charging of the battery by the charging circuit in response to detection of the overvoltage state of the battery.

2. The electronic device of claim 1, wherein the first IC is configured to operate independently of the second IC.

3. The electronic device of claim 1, wherein the first threshold is zero or takes on a value near zero.

4. The electronic device of claim 1, wherein the controller is configured to stop charging of the battery by the charging circuit if full-charge information acquired from the first IC indicates that the battery is in a full charge state.

5. The electronic device of claim 1, wherein the controller is configured to execute communication with the first IC via a serial bus.

6. The electronic device of claim 1, wherein the battery comprises a one-cell series battery pack.

7. A method for charge control applied to an electronic device comprising a controller configured to perform power management of the electronic device, and a charging circuit configured to charge a battery by using DC power from an AC power supply device, the battery comprising a first IC configured to output information regarding the battery and a second IC configured to detect whether a voltage of the battery is an overvoltage, and turn off a switch in a charging line in the battery if it is detected that the voltage of the battery is the overvoltage,
the method comprising:
detecting that the battery is in an overvoltage state if conditions that the battery is being charged, a charging current value of the battery acquired from the first IC is not greater than a first threshold, and power usable by the charging circuit to charge the battery is unrestricted are satisfied; and
stopping charging of the battery by the charging circuit in response to detection of the overvoltage state of the battery.
